(19) United States
(12) Patent Application Publication
(10) Pub. No.: US 2016/0078466 A1
(43) Pub. Date: Mar. 17, 2016

(54) MANAGING LOYALTY REWARDS

(71) Applicant: Ten Six, LLC, Chicago, IL (US)

(72) Inventor: Jonathan Markowitz, Chicago, IL (US)

(21) Appl. No.: 14/489,114

(22) Filed: Sep. 17, 2014

(51) Int. Cl. G06Q 30/02; H04W 4/02; G06Q 20/32; H04W 76/02; H04W 4/00

(52) U.S. Cl. CPC G06Q 30/0233; H04W 76/023; H04W 4/008; G06Q 20/3224; H04W 4/021

(57) ABSTRACT

A loyalty rewards management system includes a server, which includes a database including current values of loyalty points customers have available for redemption with vendors from whom the customers have earned loyalty points, wherein each of the current values of loyalty points corresponds to a particular customer and a particular vendor. The server also includes an interaction tracker that is configured to record an interaction between the customer and the vendor. The system also includes a vendor device and a customer device. The customer device includes a location determining system that is involved in a determination of whether the customer device is in proximity to the vendor device. The interaction tracker is configured to receive interaction information from the customer device and/or the vendor device and update the current value of loyalty points corresponding to the customer and the vendor based thereon.

### BACKGROUND

Repeat business and increasing customer loyalty is crucial to the survival of a business. Loyalty reward programs to drive repeat business and increase customer loyalty have existed in many forms over the years. Vendors throughout history have given free items to favored and frequent customers. To codify the system, vendors turned to punch cards that allowed a customer to get a free tenth purchase. Later, vendors advanced to cards with bar codes and some vendors use mobile applications. Others created clubs and programs that customers could join to get certain benefits like coupons and discounts. Some businesses give a discount on every purchase, others may give in store credit at a future date, and others give away items for fulfilling certain conditions.

All of these programs presented problems for the average consumer. The cards were easy to lose, bulky to carry, and hard to remember. Customers tended to collect multiple cards from the same vendor, and this made the crucial final punch harder to receive. The systems were often narrowly focused and unable to adapt to the different levers that drive different customers. Many systems were unable to distinguish between types of purchases and value spent, and attempted a one-size-fits-all approach.

While such systems may encourage customers to return to the store, they do not give information back to the vendor. While punch cards track purchases made by a customer, the vendor cannot access the information until the card is used up. They do not give any information about frequency of purchases or what kinds of items were purchased. General discounts do not target the areas of customer demand and do not drive high profit margin sales.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

An embodiment of the present invention is directed to a system for managing loyalty rewards among a plurality of vendors and a plurality of customers. The system includes a server. The server includes a database including current values of loyalty points the customers have available for redemption with the vendors from whom the customers have earned loyalty points, wherein each of the current values of loyalty points corresponds to a particular customer and a particular vendor. The server also includes an interaction tracker that is configured to record an interaction between the customer and the vendor. The system also includes a vendor device associated with one of the vendors and in communication with the server, as well as a customer device associated with one of the customers and in communication with the server and the vendor device. The customer device includes a location determining system that is involved in a determination of whether the customer device is in proximity to the vendor device. The interaction tracker is configured to receive interaction information from one or more of the customer device and the vendor device describing an interaction between the customer associated with the customer device and the vendor associated with the vendor device. The interaction tracker is also configured to update the current value of loyalty points corresponding to the customer associated with the customer device and the vendor associated with the vendor device, based upon the interaction information.

Another embodiment of the present invention is directed to a method for managing loyalty rewards among a plurality of vendors and a plurality of customers. The method includes receiving at a server customer information from a customer device associated with one of the customers; storing the customer information in a customer profile in a database on the server; receiving at the server first vendor information from a first vendor device associated with a first vendor; establishing a current value of first loyalty points corresponding to the customer associated with the customer device and the first vendor; storing the first vendor information in a first vendor profile in the database; receiving at the server second vendor information from a second vendor device associated with a second vendor; storing the second vendor information in a second vendor profile in the database; establishing a current value of second loyalty points corresponding to the customer associated with the customer device and the second vendor; receiving first interaction information from one or more of the customer device and the first vendor device describing a first interaction between the customer associated with the customer device and the first vendor; updating the current value of the first loyalty based upon the first interaction information; receiving second interaction information from one or more of the customer device and the second vendor device describing a second interaction between the customer associated with the customer device and the second vendor; and updating the current value of the second loyalty points based upon the second interaction information.

Another embodiment of the present invention in directed to a method for distributing loyalty rewards to a plurality of consumers for a plurality of vendors, wherein a vendor device is associated with one of the vendors. The method includes the vendor device establishing communication with a server and a customer device associated with one of the customers; determining that the customer device is in proximity to the vendor device; receiving customer identification information from at least one of the server and the customer device; displaying the customer information on a display of the vendor device; receiving, from a database on the server, a current value of loyalty points associated with the customer corresponding to the customer device and the vendor corresponding to the vendor device; recording interaction information concerning an interaction between the customer and the vendor; transmitting the interaction information to the server; and receiving an updated value of the loyalty points from the server in response to the transmitted interaction information.

Another embodiment of the present invention is directed to a method for tracking and utilizing loyalty rewards at a plurality of vendors. The method includes establishing communication with a server; determining that the customer is in proximity to a vendor device associated with one of the vendors. The method further includes, in response to determining that the customer device is in proximity to the vendor device, receiving the vendor identification information; receiving a current value of loyalty points associated with the customer and the vendor from a database on the server; displaying the vendor identification information and the current value of the loyalty points on a display of the customer device; recording interaction information concerning an interaction between the customer and the vendor; transmitting the interaction information to the server; and receiving an updated value of the loyalty points from the server in response to the transmitted interaction information.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a block diagram of an exemplary system for implementing embodiments, in accordance with various embodiments of the present invention;

FIG. 2 illustrates a block diagram of a loyalty rewards system, in accordance with an embodiment of the present invention;

FIG. 3 shows an example of a notification screen that may be displayed to a customer, in accordance with an embodiment of the present invention;

FIG. 4 shows an example of a first informational screen that may be displayed to the vendor, in accordance with an embodiment of the present invention;

FIG. 5 shows an example a second informational screen that may be displayed to the vendor, in accordance with an embodiment of the present invention;

FIG. 6 shows an example report that may be generated by an analytics engine, in accordance with an embodiment of the present invention;

FIG. 7 illustrates a flowchart for a method for tracking loyalty rewards, in accordance with various embodiment of the present invention;

FIG. 8 illustrates a flowchart of a method for updating loyalty points based on received interaction information, in accordance with various embodiments of the present invention;

FIG. 9 illustrates a flowchart of a method for updating loyalty points based on received interaction information, in accordance with various embodiments of the present invention;

FIG. 10 illustrates a flowchart for a method for tracking loyalty rewards, in accordance with various embodiment of the present invention;

FIG. 11 illustrates a flowchart for recording a purchase interaction, in accordance with various embodiments of the present invention;

FIG. 12 illustrates a flowchart for a method for tracking loyalty rewards, in accordance with various embodiment of the present invention; and

FIG. 13 illustrates a flowchart, for determining whether a customer device is in proximity to a vendor device, in accordance with various other embodiments of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

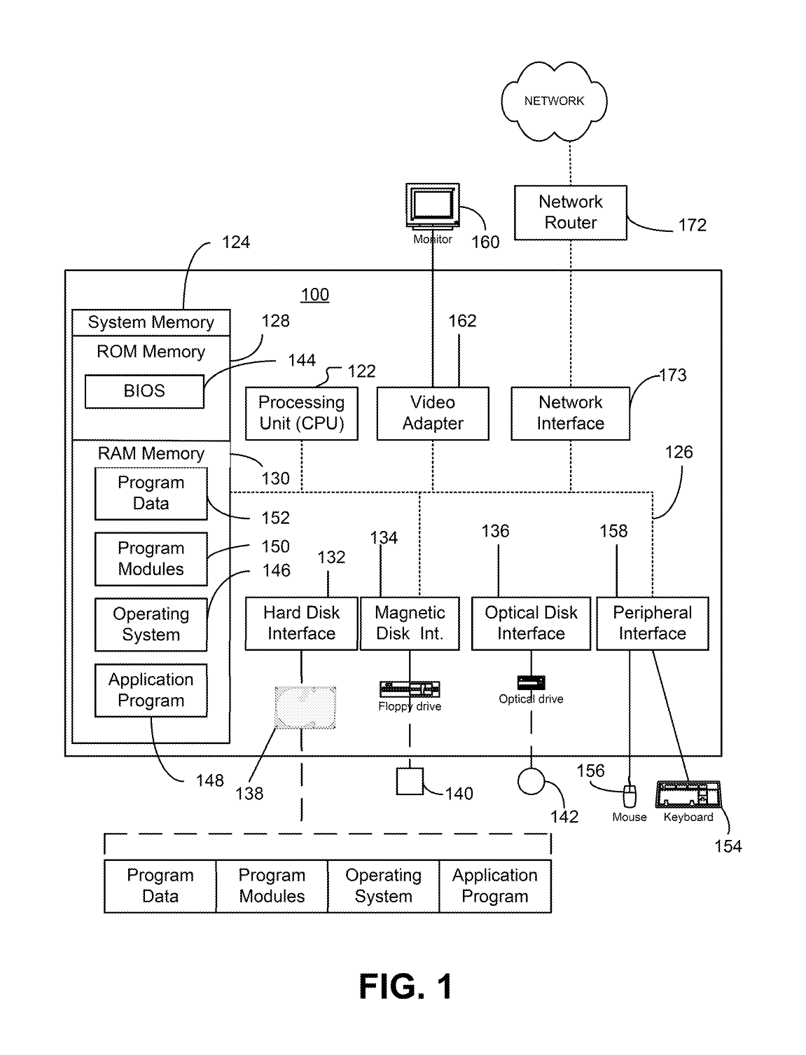

With reference to FIG. 1, an exemplary system for implementing embodiments includes a general purpose computing system environment 100, such as a desktop computer, laptop, smartphone, tablet, or any other such device having the ability to execute instructions, such as those stored within a non-transient, computer-readable medium. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 122 and at least one memory 124, which may be linked via a bus 126. Depending on the exact configuration and type of computing system environment, memory 124 may be volatile (such as RAM 130), non-volatile (such as ROM 128, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 132, a magnetic disk drive interface 134, an optical disk drive interface 136, and/or an interface for other forms of removable storage, such as flash memory. As will be understood, these devices, which would be linked to the system bus 126, respectively, allow for reading from and writing to a hard disk 138, reading from or writing to a removable magnetic disk 140, and/or for reading from or writing to a removable optical disk 142, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 144, containing the basic routines that help to transfer information between elements within the computing system environment 100, such as during start-up, may be stored in ROM 128. Similarly, RAM 130, hard drive 138, and/or peripheral memory devices may be used to store computer executable instructions comprising an operating system 146, one or more applications programs 148, other program modules 150, and/or program data 152. Still further, computer-executable instructions may be downloaded to one or more of the computing devices as needed, for example, via a network connection.

An end-user, e.g. a consumer, may enter commands and information into the computing system environment 100 through input devices such as a keyboard 154 and/or a pointing device 156. While not illustrated, other input devices may include a touchscreen interface, a microphone, a joystick, a game pad, a scanner, etc. These and other input devices would typically be connected to the processing unit 122 by means of a peripheral interface 58 which, in turn, would be coupled to bus 126. Input devices may be directly or indirectly connected to processor 122 via interfaces such as, for example, a parallel port, game port, firewire, or a universal serial bus (USB). To view information from the computing system environment 100, a monitor 160 or other type of display device may also be connected to bus 126 via an interface, such as via video adapter 162. In addition to the monitor 160, the computing system environment 100 may also include other peripheral output devices, not shown, such as speakers and printers.

The computing system environment 100 may also utilize logical connections to one or more remote computing system environments. In this regard, it will be appreciated that the remote computing system environment may, like computing system environment 100, be any type of device having processing capabilities. Again, it will be appreciated that the remote computing system environment need not be implemented as a single device but may be implemented in a manner such that the tasks performed by the remote computing system environment are distributed to a plurality of computing system environments linked through a communication network.

For performing tasks as needed, the remote computing system environment may include many or all of the elements described above relative to the computing system environment 100. Communications between the computing system environment 100 and the remote computing system environment may be exchanged via a further processing device, such a network router 172, that is responsible for network routing. Communications with the network router 172 may be performed via a network interface component 173. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the remote computing system environment.

Generally speaking, embodiments provide methods, systems and apparatuses for enabling centralized tracking of customer loyalty points across multiple vendors and in a vendor-specific manner. By virtue of the technology described herein, including various types of location-tracking features, customers can automatically receive loyalty rewards for various types of activities and interactions—not just for consummating a purchase with a vendor.

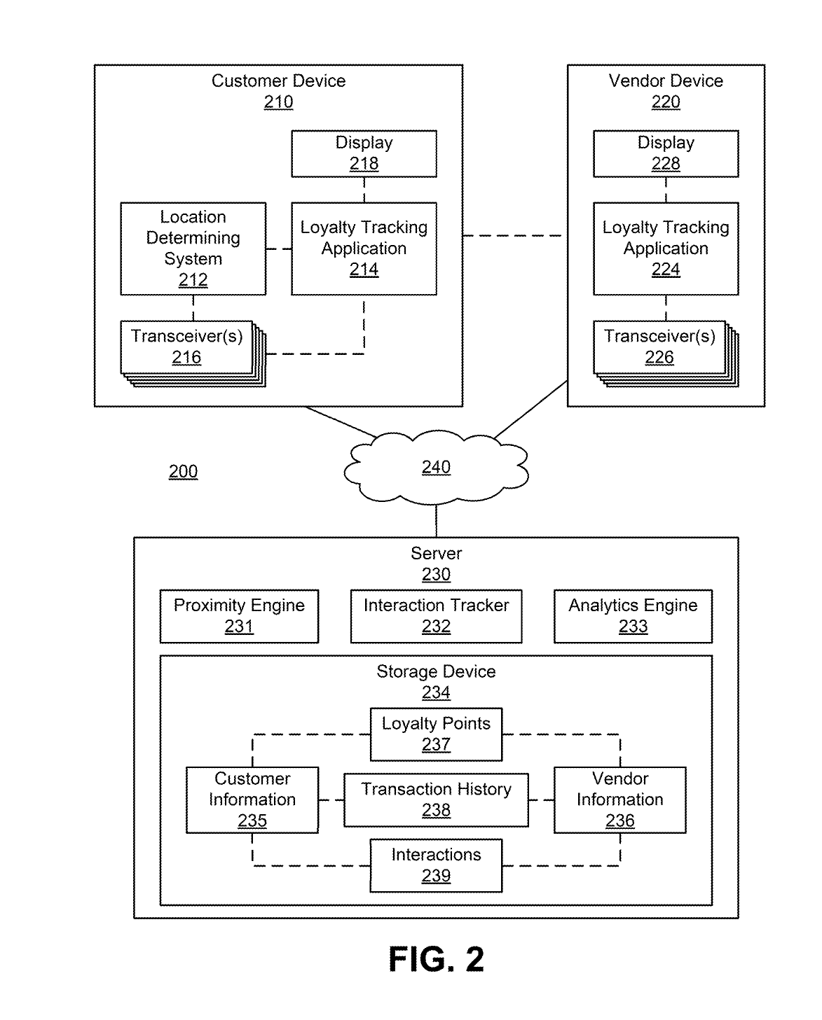

FIG. 2 illustrates a block diagram of a loyalty rewards system 200, in accordance with an embodiment of the present invention. System 200 includes a customer device 210, which may be a computing system environment 100, such as that depicted in FIG. 1, and preferably is a mobile computing device, such as a laptop computer, smartphone, tablet or the like. System 200 is intended to support numerous customer devices 210, but for simplicity, only a single customer device 210 is shown in FIG. 2. The customer device 210 includes a location determining system 212 for determining the position of customer device 210. The location determining system 212 may perform the location determination in conjunction with one or more transceivers 216, including but not limited to cellular transceivers, GPS transceivers, IEEE 802.11 (Wi-Fi) transceivers, near field communication (NFC) transceivers, and Bluetooth (traditional and/or low energy (LE)) transceivers. In that regard, the location of the customer device 210 may be determined through cellular triangulation, GPS geolocation, a Wi-Fi-based positioning system (WPS), or the like. Still further, as will be described in more detail below, the location determining system 212 may also determine the location of the customer device 210 by coming into short range communication (e.g. NFC, Bluetooth) with a vendor device 220 that has a known location. The transceivers 216 may also enable the customer device 210 to communicate with other devices, such as vendor device 220 and server 230, either through direct link or indirectly through a network 240.

The customer device 210 also includes a loyalty tracking application 214, which is adapted to establish communication with a server 230 and/or a vendor device 220 and interact with them towards enabling the customer to accrue loyalty points with the vendor. Those operations of loyalty tracking application 214 will be described in greater detail below.

System 200 also includes vendor device 220, which may be a computing system environment 100, such as that depicted in FIG. 1, and preferably is a mobile computing device, such as a laptop computer, smartphone, tablet or the like. System 200 is intended to support numerous vendor devices 220, but for simplicity, only a single vendor device 220 is shown in FIG. 2. Like client device 210, vendor device 220 also includes one or more transceivers 226, which likewise may include but are not limited to cellular transceivers, GPS transceivers, Wi-Fi transceivers, NFC transceivers, and Bluetooth (traditional and/or low energy (LE)) transceivers. The transceivers 226 enable the vendor device 220 to communicate with other devices, such as customer device 210 and server 230, either through direct link or indirectly through a network 240.

The vendor device 220 also includes a loyalty tracking application 224, which is adapted to establish communication with a server 230 and/or a customer device 210 and interact with them towards enabling the customer to accrue loyalty points with the vendor. Those operations of loyalty tracking application 224 will be described in greater detail below.

System 200 also includes a server 230, which may be a computing system environment 100, such as that depicted in FIG. 1. Server 230 is coupled to a network 240, through which it may establish communication with client device 210 and/or vendor device 220, and operates, at least in part, to facilitate, track and log interactions between customer device 210 and vendor device 220; to track the earning and redemption of loyalty points between customer device 210 and vendor device 220; and to generate and provide vendors with analytical reports concerning customer interactions with them.

Server 230 includes a storage device 234 for storing, inter alia, a database of customer information 235, vendor information 236, current and historical loyalty points 237, transaction histories 238, and/or customer-vendor interactions 239. The customer information 235 may include profiles for each of the customers that have created accounts with the server 230. Those profiles may contain various types of information concerning the customers, such as a given customer's name, address, e-mail address, phone number and other biographical information; social network information and credentials; bank, credit card and/or other financial information for purchases; demographics; and customer interests, but are not limited as such. The customer device 210 may also store such customer information in a memory thereof.

The vendor information 236 may include profiles for each of the vendors that have created accounts with the server 230. Those profiles may contain various types of information concerning the vendor, such as a given vendor's name, address, e-mail address, phone number and other biographical information; social network information and credentials; bank or other financial information for receipt of funds for customer purchases; hours, price lists, survey questions, reward offers, a table of reward values for certain interactions, and specifications for redeeming loyalty points (e.g. discounts, complimentary items, or exclusive offers), but are not limited as such. The vendor device 220 may also store such vendor information in a memory thereof.

As discussed above, some embodiments maintain loyalty point records 237 on a customer- and vendor-specific basis. Thus, customers may interact with multiple vendors and earn individualized loyalty points that are specific to the customer's interactions with each such vendor. Although described herein as “points,” it should be appreciated that such loyalty rewards may be offered in the form of cash equivalents, or in various other forms, without deviating from the spirit and scope of embodiments of the present invention. As shown in FIG. 2, each loyalty point record 237 is linked to a particular customer and a particular vendor. A given loyalty point record 237 preferably includes a current value of the loyalty points (or the equivalent thereof) the linked customer has for redemption from the linked vendor. The loyalty point record 237 may also include historical loyalty point records, such as instances in which the customer earned loyalty points from the vendor and instances in which the customer redeemed loyalty points with the vendor.

As will be described in further detail below, various embodiments facilitate purchases between customers and vendors. As such, storage device 234 may also maintain a transaction history 238 as between a given customer and a given vendor.

Storage device 234 also stores a record of interactions 239 between a given customer and a given vendor. Interactions 239 may include, but are not limited to, the customer posting to a social media website regarding the vendor, the customer passing by the vendor's location, the customer entering the vendor's location, the customer being within a certain area of the vendor's location for a specified amount of time, the customer making a purchase with the vendor, the customer participating in a survey from the vendor, the customer writing a review about the vendor, the customer referring a new user, and/or the customer signing up for notifications or special offers from the vendor. To that end, server 230 includes an interaction tracker 232 which receives interaction information from the customer device 210, the vendor device 220, and/or the proximity engine 231. Based on the nature of the interaction and the value assigned to that interaction by the vendor, the interaction tracker 232 may update a current value of the loyalty points 237 associated with the customer and the vendor. Various embodiments include a robust rules engine to permit a vendor to customize the rules under which the vendor's loyalty points are awarded. For example, in the case of awarding loyalty points to a customer for posting to a social media site, some vendors may prefer to award a fixed value, whereas other vendors may prefer to weight the amount of points awarded based on the customer's number of social media connections (e.g. awarding more points to a customer with 300 connections than to a customer with only 30 connections).

As should be appreciated, a number of the customer-vendor interactions described above involve a determination that the customer device 210 and the vendor device 220 are in proximity to each other, or, put differently, that the customer is near or inside the vendor's location for a period of time. To that end, server 230 includes a proximity engine 231, which is adapted to determine whether the customer device 210 and the vendor device 220 are in proximity to each other. The determination of whether the customer device 210 and the vendor device 220 are in proximity to each other may be achieved a number of ways. Generally speaking, it is presumed that the vendor device is in a fixed location—the location of the vendor's business. However, it should be appreciated that in instances where the vendor is mobile, such as in the case of a food truck, the location of the vendor device 220 may be determined in any of the manners described in relation to the customer device 210 hereinbelow.

In one embodiment, the customer device 210 and the vendor device 220 may themselves determine that they are in proximity to each other by virtue of being able to communicate with each other over short-range protocols, such as Bluetooth or NFC, or by discovering that they are both connected to the same Wi-Fi hotspot or LAN. In that case, the customer device 210 and/or the vendor device 220 may simply notify the proximity engine 231 of server 230 that they are in proximity to each other. In another embodiment, the customer device 210 may utilize a location determining system 212 to geolocate itself (e.g. via cellular triangulation, GPS, WPS or the like) and provide its location to the proximity engine 231 of the server 230. The proximity engine 231 then compares the location of the customer device 210 to the known location of the vendor device 220 towards determining whether they are in proximity to each other. Once the proximity engine 231 determines that the customer device 210 and the vendor device 220 are in proximity to each other, it notifies the interaction tracker 232. In one embodiment, the notification that the proximity engine 231 provides to the interaction tracker includes a duration that the customer device 210 and the vendor device 220 were in proximity to each other. Then depending on the vendor's preferences set in vendor information 236, the interaction tracker may award varying amounts of loyalty points 237 to the customer, based on such factors as whether the customer simply passed by the vendor's establishment, whether the customer entered the establishment, how long the customer was in the establishment, whether the customer was in a particular area of the establishment, how long the customer was in a particular area of the establishment, etc.

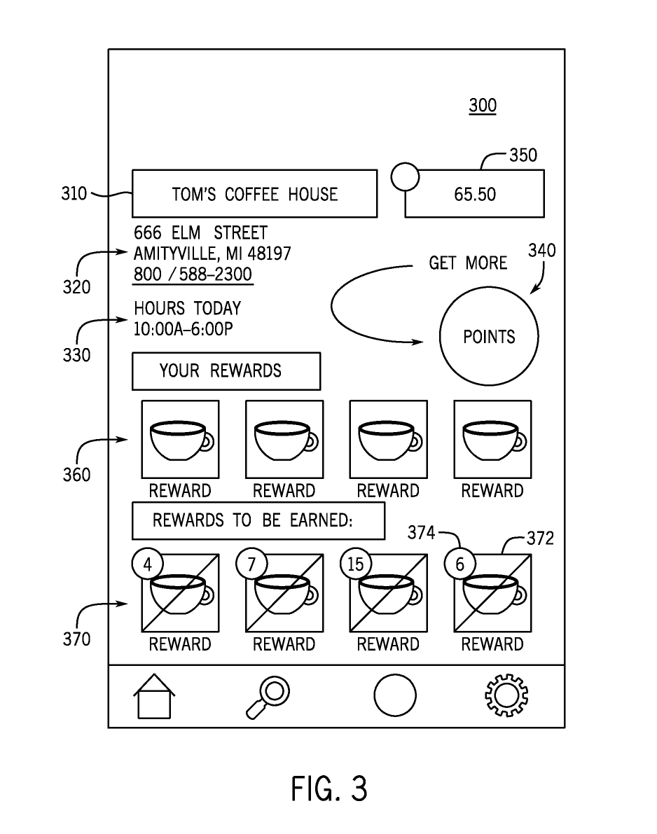

In addition to simply awarding loyalty points to the customer, various embodiments of the present invention include other advantageous features that involve the determination that the customer device 210 and the vendor device 220 are in proximity to each other. For example, customer device 210 may generate an alert to the customer (e.g. via display 218), notifying the customer that he or she is nearby the vendor. That notification may include a special offer to entice the customer to enter the vendor's establishment. FIG. 3 shows an example of one such notification screen 300 that may be displayed to the customer, in accordance with an embodiment of the present invention. As shown, the notification screen 300 can provide various types of information about the vendor, including the vendor name 310, address 320 and business hours. Additionally, the screen 300 can show the customer's current loyalty point balance 350 with the vendor, rewards that the customer has earned 360 from the vendor, and special offers 370 from the vendor through which the customer can earn additional rewards. Still further, the customer may be able to activate a “GET MORE” icon to view more special offers from the vendor for earning more loyalty points, including for example a module that facilitates the posting of a message to social media or a survey.

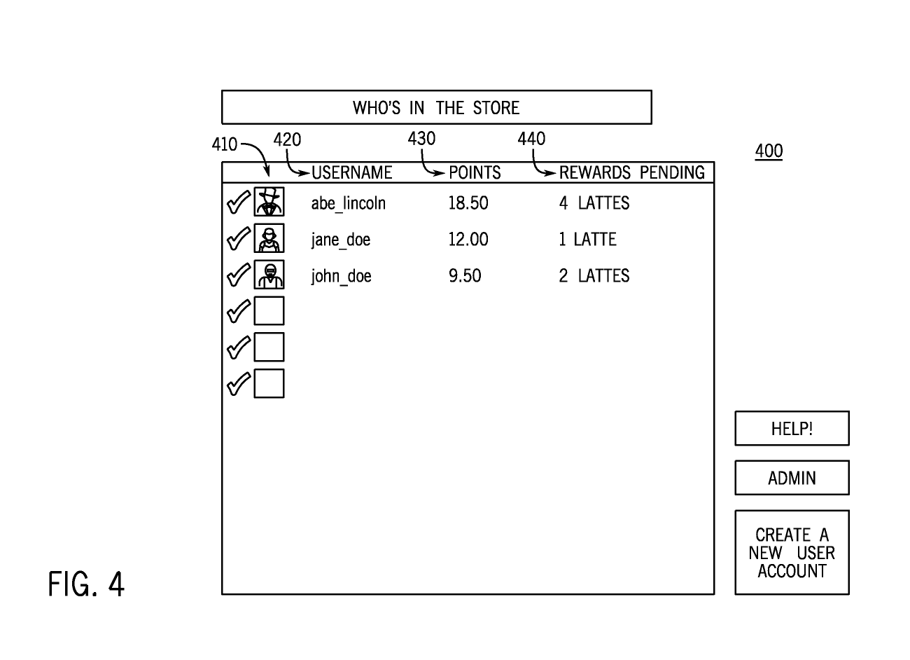

The vendor device 220 may also display certain notifications or information on display 228 in response to the vendor device 220 coming into proximity with the customer device 210. For example, vendor device 220 may display an identification of all customers that are in proximity to vendor device 220. FIG. 4 shows an example of one such informational screen 400 that may be displayed to the vendor, in accordance with an embodiment of the present invention. As shown, informational screen 400 may display photos 410 of the customers, usernames 420 (or actual names) of the customer, their loyalty point balances 430 with the vendor, and any pending rewards 440 the customers may have with the vendor. It should be appreciated that informational screen 400 is merely exemplary, and other displays with other information is contemplated herein. Such proactive displays create an “augmented reality” experience between the vendor and its customers, whereby the vendor can, for example, greet customers by name, offer to get them their usual order, etc.

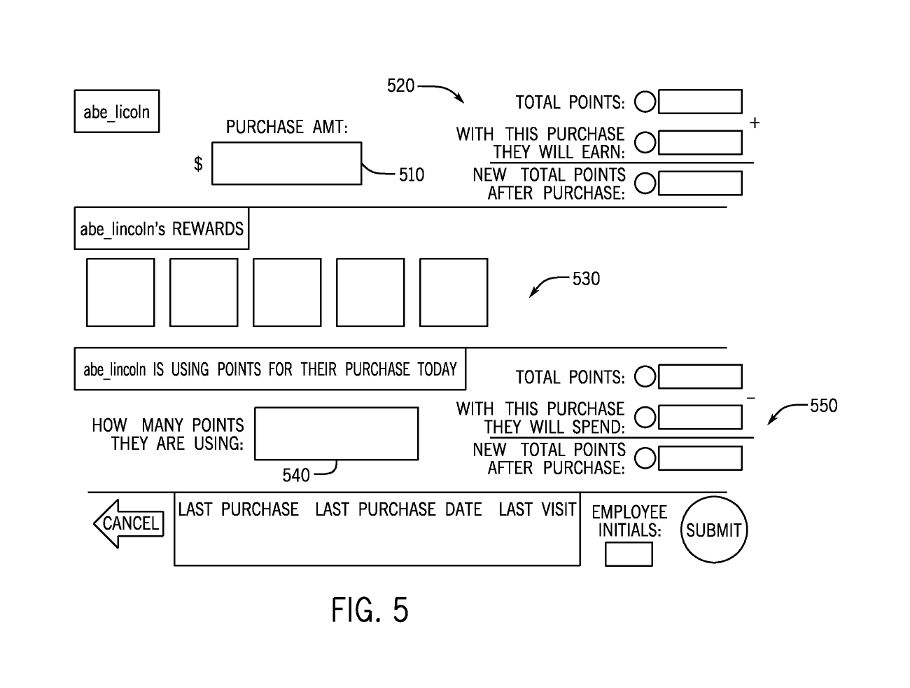

Once a customer has entered the vendor's establishment, and the customer desires to make a purchase, various embodiments can facilitate the transaction between the customer and the vendor. For example, the vendor device may be coupled to or integrated with the vendor's point-of-sale device, such that the loyalty tracking application 224 on the vendor device can import transactional information from the point-of-sale device, such as the goods or services being purchased, price, total, etc. Alternatively, the vendor can manually enter the transactional information into the loyalty tracking application 224. In either case, the loyalty tracking application 224 can then display the information on display 228, together with information concerning the amount of loyalty points the customer will earn (or redeem, as the case may be) for completing the transaction. FIG. 5 shows an example of one such informational screen 500 that may be displayed to the vendor, in accordance with an embodiment of the present invention. As shown, informational display 500 may show the purchase amount 510, a breakdown of loyalty points earned for the transaction 520 (assuming the customer is not redeeming loyalty points for the purchase), a representation of any outstanding rewards 530 the customer may have with the vendor, and a breakdown of loyalty points redeemed (assuming the customer is redeeming loyalty points for the purchase). It should be appreciated that informational screen 500 is merely exemplary, and other displays with other information is contemplated herein. Additionally at the point of sale, embodiments may also facilitate the transfer of funds for the purchase. For example, within the customer information 235 in the storage device 234, the customer may have saved credit card and/or bank account and routing information, and within the vendor information 236, the vendor may have also saved bank account and routing information. As such, in response to transaction information provided by loyalty tracking application 224 of vendor device 220 and, for example, and confirmation provided by loyalty tracking application 214 of customer device 210, server 230 may initiate a credit card or ACH payment from the customer to the vendor.

In one embodiment, one or more vendors may choose to participate in, or initiate, a team-based game, promotion or offer, wherein a plurality of customers (i.e. customer team) are offered reward(s) for participating. Such a game, promotion or offer may be initiated by server 230, or may be initiated by any vendor or group of vendors from their respective vendor device(s) 220. For example, server 230, a vendor or a group of vendors may offer a scavenger hunt or treasure hunt in which a plurality of vendors' products or service are implicated. The participating customer or customer team may then be awarded loyalty points for one or more of the participating vendors as a result of completing certain tasks.

In addition to the various real-time benefits described above, various embodiments also provide tangible benefits to the vendors after-the-fact, for example, in the form of reports describing customer interactions with the vendor (both individually and in the aggregate) and other market research, such as details about which of the vendor's good/services are most popular, historical trends of the business, and what the busiest times are for purchasing and redemption of points. Using demographics information supplied the analytics engine can also provide information about customer segmentation and effectiveness of loyalty reward efforts. The analytics can also process the data on a larger scale so that vendors can see how their numbers compare to other similar or local businesses. To that end, server 230 may include an analytics engine 233 that is adapted to analyze the data in storage device 234, generate one or more reports based thereon, and transmit the report(s) to the vendor device 220. The analytics engine 233 can also compile data based on historical transaction records.

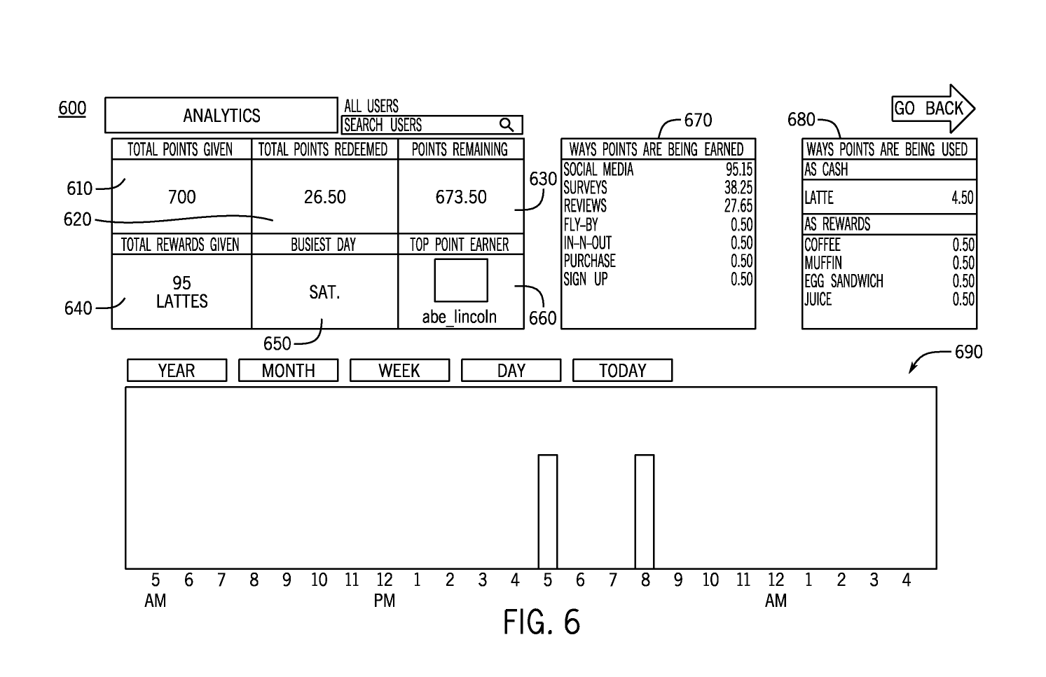

FIG. 6 shows an example report 600 that may be generated by the analytics engine 233, in accordance with an embodiment of the present invention. As shown, the analytics engine may calculate and provide in the report 600 the total loyalty points the vendor has given out to date 610, the total points that customers have redeemed to date 620, the total amount of loyalty points that have been issued but not yet redeemed 630, the total number of rewards given 640, the busiest day 650, the top loyalty point-earning customer 660, a breakdown of the ways in which customers have been earning loyalty points 670, a breakdown of the ways in which customers have been redeeming points 680, and one or more graphs 690 (e.g. for showing sales by hour, day, week, month, year, etc.).

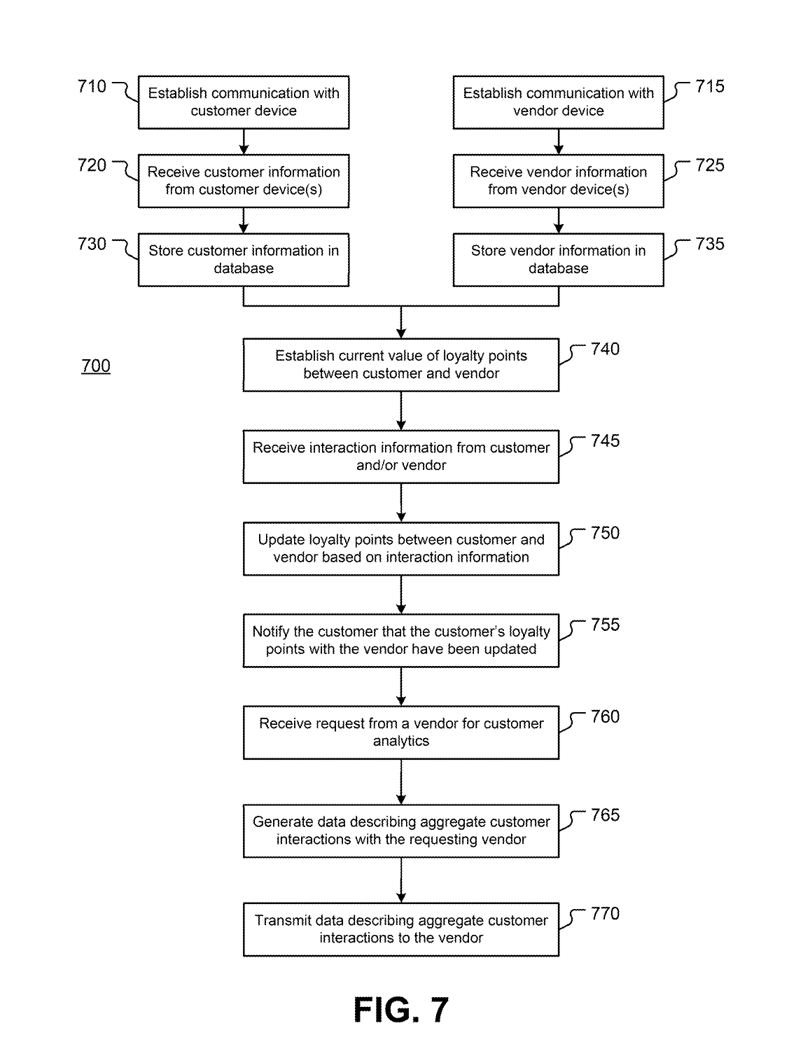

The following discussion sets forth in detail the operation of present technology for a loyalty tracking system. With reference to FIGS. 7-13, flowcharts 700, 750A, 750B, 1000, 1030A, 1200 and 1210A each illustrate example steps used by various embodiments of the present technology for a loyalty tracking system 200. Flowcharts 700, 750A, 750B, 1000, 1030A, 1200 and 1210A include processes that, in various embodiments, are carried out by a processor under the control of computer-readable and computer-executable instructions. The computer-readable and computer-executable instructions may reside, for example, in data storage features such as storage media 138, 140 and 142 of FIG. 1. Although specific operations are disclosed in flowcharts 700, 750A, 750B, 1000, 1030A, 1200 and 1210A, such operations are examples. That is, embodiments are well suited to performing various other operations or variations of the operations recited in flowcharts 700, 750A, 750B, 1000, 1030A, 1200 and 1210A. It is appreciated that the operations in flowcharts 700, 750A, 750B, 1000, 1030A, 1200 and 1210A may be performed in an order different than presented, and that not all of the operations in flowcharts 700, 750A, 750B, 1000, 1030A, 1200 and 1210A may be performed. Where helpful for the purposes of illustration and not for limitation, FIGS. 7-13 will be described with reference to FIGS. 1-6, which illustrate hypothetical situations in which embodiments may be implemented.

FIG. 7 illustrates a flowchart 700 for a method for tracking loyalty rewards, in accordance with various embodiment of the present invention. While operations of flowchart 700 will generally be described herein as being performed by a server 230, it should be appreciated that some or all of those operations could be performed locally, i.e. by a customer device 210 or a vendor device 220. Further, while flowchart 700 generally refers to a single customer and a single vendor, and their corresponding devices, it should be appreciated that the various embodiments may involve multiple customers and multiple vendors.

Flowchart 700 begins at blocks 710 and 715, where the server 230 establishes communication with the customer device 210 and the vendor device 220, respectively. The server 230 then receives customer information 235 and vendor information 236 from the customer device 210 and the vendor device 220, respectively (blocks 720 and 725). The customer information 235 and vendor information 236 may include any of the information described above. The server 230 then stores the customer information 235 and 236 in storage device 234, which may be a database (blocks 730 and 735). At block 740, a current value of loyalty points is established between the customer and the vendor. This may simply be zero, but in some instances, a vendor may wish to give a customer a specific amount of loyalty points at the outset in order to initially encourage the customer's patronage. At block 745, interaction information is received from the customer and/or the vendor, which may describe an interaction between a customer and a vendor, such as those described above. In one embodiment, instead of describing an interaction, the interaction information may include location information for one or both of the customer device 210 and the vendor device 220, which the server 230 may use to determine whether a location-dependent interaction has occurred between the customer and vendor.

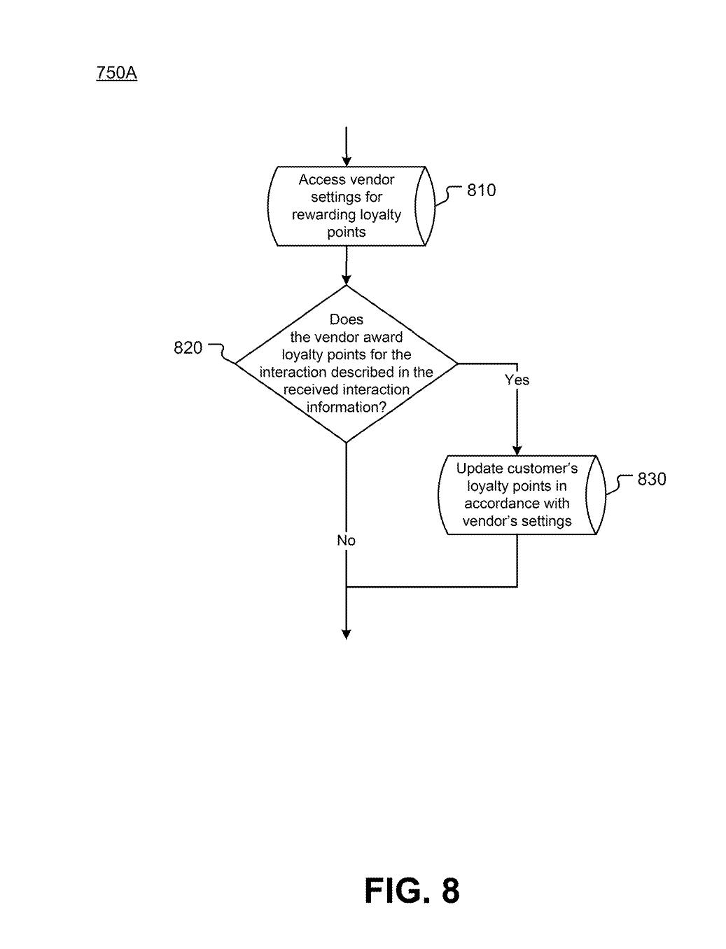

At block 750, the loyalty points between the customer and the vendor are updated based on the received interaction information. It should be appreciated that this may be achieved in a number of ways, i.e. according to a number of different rules and/or algorithms. For example, FIG. 8 illustrates a flowchart 750A of a method for updating loyalty points based on received interaction information, in accordance with various embodiments of the present invention. Flowchart 750A begins at block 810, where vendor settings for rewarding loyalty points (e.g., in vendor information 236) are accessed. As discussed above, a vendor has the ability to set rules and preferences for when and under what circumstances loyalty points are awarded to customers. At block 820, a determination is made as to whether, based on the vendor's settings, the vendor awards loyalty points for the interaction described in the received interaction information. If not, then flowchart 750A simply proceeds to block 755 of FIG. 7 without modifying the current loyalty point value between the customer and the vendor. If, however, the vendor does award loyalty points for such an interaction, flowchart 750A proceeds to block 830, where the customer's loyalty points corresponding to the vendor are updated in accordance with the vendor's settings.

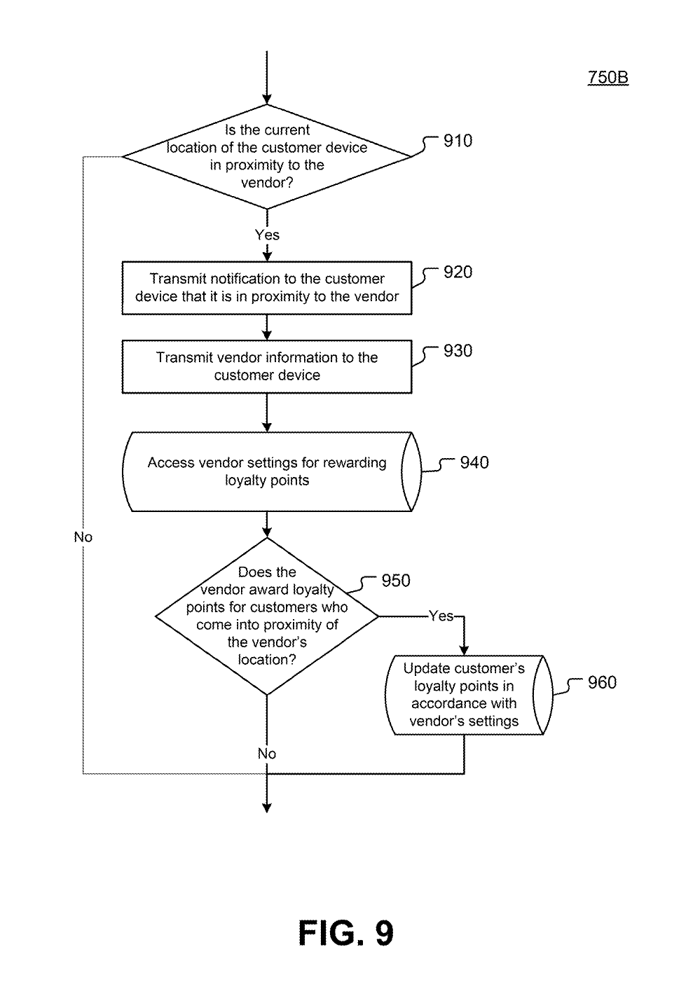

As discussed above, in some embodiments, the received interaction information includes location information concerning the customer device 210 and/or the vendor device 220, and the vendor may award loyalty points to a customer based at least in part on the customer's location. FIG. 9 illustrates a flowchart 750B of a method for updating loyalty points based on received interaction information, in accordance with such embodiments. Flowchart 750B begins at block 910, where a determination is made as to whether the current location of the customer device 210 is in proximity to the vendor. In an embodiment in which the customer device 210 and the vendor device 220 establish communication with each other via a short-range protocol, such as Bluetooth, NFC or Wi-Fi, such a determination may be made by simply receiving a notification from the customer device 210 and/or the vendor device 220 that such communication has been established. In other embodiments in which the location information received from a customer device 210 only provides the current location of the customer device 210, the proximity engine 231 of the server 230 may compare the received location of the customer device 210 with a known or received location of vendor device 220. If it is determined that the customer device 210 is not in proximity to the vendor device 220, then flowchart 750B simply proceeds to block 755 of FIG. 7 without modifying the current loyalty point value between the customer and the vendor. If, however, it is determined that the current location of customer device 210 is in proximity to the vendor device, flowchart 750B proceeds to block 920, where a notification is sent to the customer device 210 that it is in proximity to the vendor device. Information about the vendor, such as its business name, address, hours, special offer (including offers for earning loyalty points) may also be transmitted to the customer device 210 (block 930).

At block 940, the vendor's settings for rewarding loyalty points are accessed. At block 950, a determination is made as to whether, based on the vendor's settings, the vendor awards loyalty points to customers who come into proximity of the vendor's location. As discussed above, this may vary from vendor to vendor, as some may award loyalty points for simply being near the establishment, but not actually being inside the establishment (e.g. a “walk-by”), whereas other may only award loyalty points to customers who actually enter the establishment. If the vendor does not award loyalty points for the customer coming into proximity of the vendor's location, then flowchart 750B simply proceeds to block 755 of FIG. 7 without modifying the current loyalty point value between the customer and the vendor. If, however, the vendor does award loyalty points for such an interaction, flowchart 750B proceeds to block 960, where the customer's loyalty points corresponding to the vendor are updated in accordance with the vendor's settings.

Referring again to FIG. 7, at block 760, the customer is notified (e.g. via a message transmitted to and displayed on customer device 210, via e-mail, etc.) that the customer's loyalty points associated with the vendor have been updated.

As discussed above, a vendor may periodically desire to obtain information and/or analytics concerning those customers to who it has awarded loyalty points, concerning customers in the aggregate, etc. Thus, at block 760, a request for customer analytics may be received from a vendor. In response, data describing aggregate customer interactions is generated (block 765) and transmitted to the vendor (block 770).

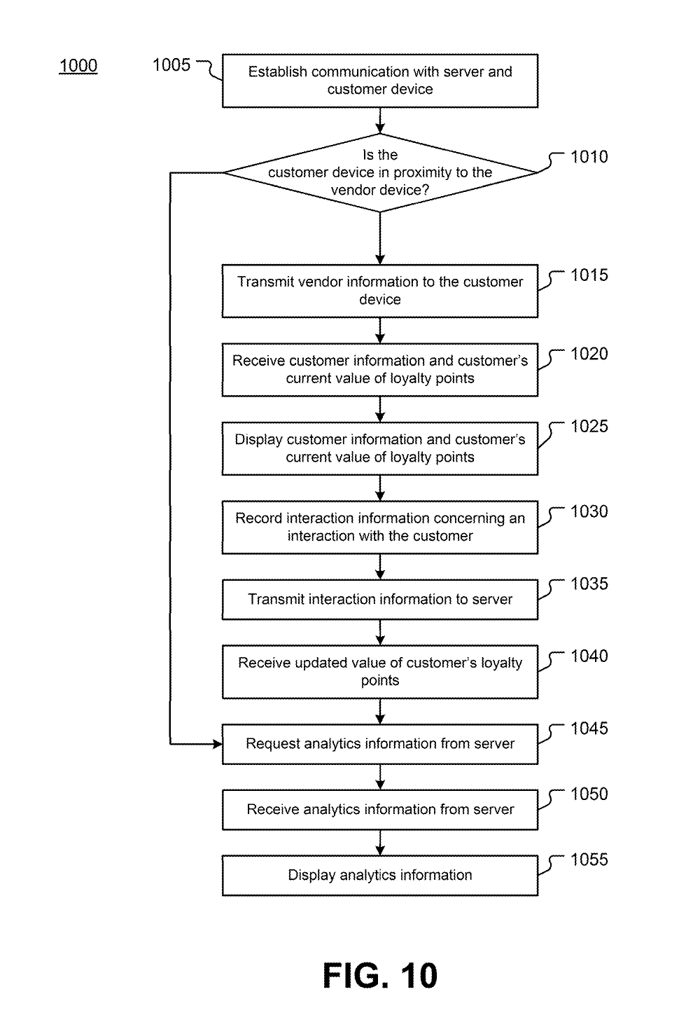

FIG. 10 illustrates a flowchart 1000 for a method for tracking loyalty rewards, in accordance with various embodiment of the present invention. While operations of flowchart 700 will generally be described herein as involving communications with a server 230, it should be appreciated that some or all of those communications could be with a customer device 210 instead. Further, while flowchart 1000 generally refers to a single customer and a single vendor, and their corresponding devices, it should be appreciated that the various embodiments may involve multiple customers and multiple vendors.

Flowchart 1000 begins at block 1005, where communication with a server 230 is established. At block 1010, a determination is made as to whether a customer device 210 is in proximity to the vendor device 220. This may involve, for example, receiving a notification from the server 230 that the customer device 210 is in proximity to the vendor device 220. Alternatively, this may involve the vendor device 220 establishing short-range communication with the customer device 210, as described elsewhere herein. If a customer device 210 is not in proximity to the vendor device 220, then flowchart 1000 proceeds to block 1055, which will be discussed below. If a customer device 210 is determined to be in proximity to the vendor device 220, then flowchart 1000 proceeds to block 1015 where, in one embodiment, vendor information is transmitted to the customer device 210. This information may be transmitted directly the customer device 210 (i.e. peer-to-peer) or indirectly via server 230. At block 1020, customer information and the customer's current value of loyalty points with the vendor are received. The customer information may include any of the customer information described herein. The customer information and current value of loyalty points are then displayed on a display of the vendor device 220 (block 1025).

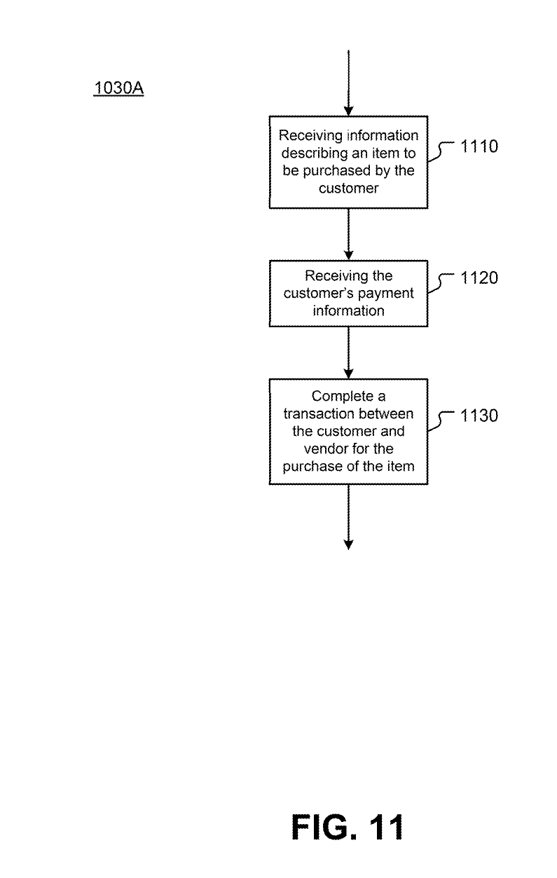

At block 1030, interaction information concerning an interaction with the customer is recorded. In one embodiment, the interaction is a purchase. Other interactions are possible, as described elsewhere herein. FIG. 11 illustrates a flowchart 1030A for recording a purchase interaction, in accordance with various embodiments of the present invention. Flowchart 1030A begins at block 1110, where information describing an item to be purchased by the customer is received. This may occur in a number of ways. For example, the information may be entered manually via a user interface of the vendor device 220, or the information may be received electronically from a point-of-sale terminal, bar code scanner, or the like. At block 1120, the customer's payment information is received. Such information may be received directly from the customer device 210 or from the server 230, which may have stored the payment information in a profile of the customer 235. At block 1130, a transaction between the customer and the vendor for the purchase of the item is completed.

Referring again to FIG. 10, after the interaction information has been recorded (block 1030), the interaction information is transmitted to the server 230 (block 1035). At block 1040, an updated value of the customer's loyalty points with the vendor (i.e. based on the transmitted interaction information) is received.

As discussed above, a vendor may periodically desire to obtain information and/or analytics concerning those customers to whom it has awarded loyalty points, concerning customers in the aggregate, etc. Thus, at block 1045, analytics information may be requested from the server 230. In response, analytics information is received from the server 230 (block 1050) and displayed on a display of the vendor (block 1055).

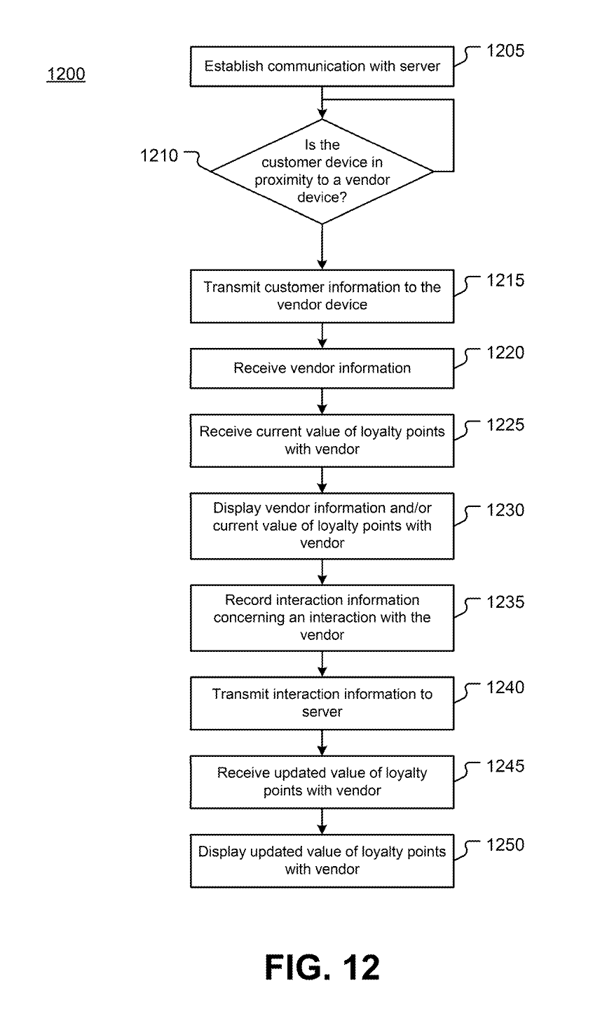

FIG. 12 illustrates a flowchart 1200 for a method for tracking loyalty rewards, in accordance with various embodiment of the present invention. While operations of flowchart 1200 will generally be described herein as involving communications with a server 230, it should be appreciated that some or all of those communications could be with a vendor device 220 instead. Further, while flowchart 1200 generally refers to a single customer and a single vendor, and their corresponding devices, it should be appreciated that the various embodiments may involve multiple customers and multiple vendors.

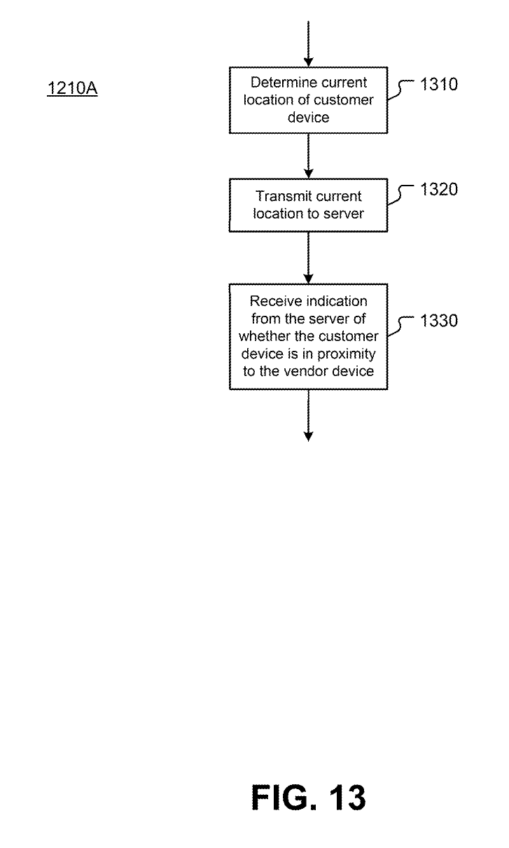

Flowchart 1200 begins at block 1205, where communication with a server 230 is established. At block 1210, a determination is made as to whether a customer device 210 is in proximity to the vendor device 220. It should be appreciated that this may be achieved in a number of ways. For example, in one embodiment, this may involve the customer device 210 establishing short-range communication with the vendor device 220, as described elsewhere herein. Alternatively, FIG. 13 illustrates a flowchart 1210A, for determining whether a customer device 210 is in proximity to the vendor device 220, in accordance with various other embodiments of the present invention. Flowchart 1210A begins at block 1310, where a current location of the customer device is determined. This may be achieved through the use of GPS, cellular triangulation, or any of other manners described elsewhere herein. At block 1320, the current location of the customer device 210 is transmitted to the server 230.

Referring again to block 1210 of flowchart 1200, if it is determined that the customer device 210 is not in proximity to a vendor device 220, the customer device 210 continues to periodically to check whether it is. If it is determined that the customer device 210 is in proximity to a vendor device 220, then flowchart 1200 proceeds to block 1215, where, in one embodiment customer information is transmitted to the vendor device 220. This information may be transmitted directly to the vendor device 220 (i.e. peer-to-peer) or indirectly via server 230. At blocks 1220 and 1225, vendor information and the customer's current value of loyalty points with the vendor are received. The vendor information may include any of the vendor information described herein. The vendor information and current value of loyalty points are then displayed on a display of the customer device 210 (block 1230).

At block 1235, interaction information concerning an interaction with the vendor is recorded. The interaction information is then transmitted to the server 230 (block 1240). At blocks 1040 and 1045, an updated value of the customer's loyalty points with the vendor (i.e. based on the transmitted interaction information) is received and displayed.

Thus, various embodiments of the present invention provide for improved management of customer loyalty rewards. Significantly, embodiments are able to track individualized customer loyalty points across multiple separate vendors. Thus, a vendor is assured that the loyalty points that a customer redeems with that vendor were earned with that vendor, as opposed to a different one, thereby leading to enhanced customer loyalty. Further, by virtue of the location-aware features described herein, various embodiments are able to encourage potential customers to patronize nearby vendors, thereby leading to potential new leads for those vendors. Embodiments can also incentivize customers, through loyalty rewards, to provide invaluable feedback to vendors.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system for managing loyalty rewards among a plurality of vendors and a plurality of customers, the system comprising:
a server comprising:
a database including current values of loyalty points the customers have available for redemption with the vendors from whom the customers have earned loyalty points, wherein each of the current values of loyalty points corresponds to a particular customer and a particular vendor; and
an interaction tracker that is configured to record an interaction between the customer and the vendor;
a vendor device associated with one of the vendors and being in communication with the server; and
a customer device associated with one of the customers and being in communication with the server and the vendor device, the customer device comprising a location determining system that is involved in a determination of whether the customer device is in proximity to the vendor device,
wherein the interaction tracker is configured to:
receive interaction information from one or more of the customer device and the vendor device describing an interaction between the customer associated with the customer device and the vendor associated with the vendor device; and
update the current value of loyalty points corresponding to the customer associated with the customer device and the vendor associated with the vendor device, based upon the interaction information.

2. The system of claim 1, wherein the server comprises a proximity engine, wherein the location determining system of the customer device is configured to determine a current location of the customer device and transmit the current location to the proximity engine, and wherein the proximity engine is configured to determine whether the current location of the customer device is in proximity to a location of the vendor device.

3. The system of claim 2, wherein the location determining system of the customer device comprises a Global Positioning System (GPS) transceiver for determining the current location of the customer device.

4. The system of claim 2, wherein the location determining system of the customer device comprises a cellular transceiver for determining the current location of the customer device.

5. The system of claim 2, wherein the location determining system of the customer device comprises an IEEE 802.11 transceiver for determining the current location of the customer device.

6. The system of claim 1 wherein the customer device and the vendor device each comprise an IEEE 802.11 transceiver, and wherein the location determining system of the customer device is configured to determine whether the customer device is on the same local area network (LAN) as the vendor device.

7. The system of claim 1, wherein the location determining system of the customer device is configured to determine whether the customer device is in proximity to the vendor device by establishing direct, short-range wireless communication with the vendor device.

8. The system of claim 7, wherein the customer device and the vendor device each comprise a Bluetooth transceiver, and the direct, short-range wireless communication is established between the Bluetooth transceivers.

9. The system of claim 8, wherein the Bluetooth transceivers are Bluetooth low energy (LE) transceivers.

10. The system of claim 7, wherein the customer device and the vendor device each comprise a Near Field Communication (NFC) transceiver, and the direct, short-range wireless communication is established between the NFC transceivers.

11. The system of claim 1 wherein the interaction between the customer associated with the customer device and the vendor associated with the vendor device includes a purchase.

12. The system of claim 1 wherein the interaction between the customer associated with the customer device and the vendor associated with the vendor device includes the customer device staying a length of time in an area determined by the vendor.

13. The system of claim 1 wherein the interaction between the customer associated with the customer device and the vendor associated with the vendor device includes the customer device entering an area determined by the vendor.

14. The system of claim 1 wherein the server comprises an analytics engine configured to determine and transmit to the vendor device data concerning aggregate customer interactions with the vendor associated with the vendor device.

15. The system of claim 1 wherein the server comprises an analytics engine configured to determine and transmit to the vendor device data concerning trends within customer interactions with the vendor associated with the vendor device.

16. The system of claim 1 wherein the analytics engine is configured to transmit data to the vendor terminal concerning information about other businesses that are within the same geographic zone as the vendor.

17. The system of claim 1 wherein the consumer device transmits payment information to the vendor terminal.

18. A method for managing loyalty rewards among a plurality of vendors and a plurality of customers, the method comprising:
receiving at a server customer information from a customer device associated with one of the customers;
storing the customer information in a customer profile in a database on the server;
receiving at the server first vendor information from a first vendor device associated with a first vendor;
establishing a current value of first loyalty points corresponding to the customer associated with the customer device and the first vendor;
storing the first vendor information in a first vendor profile in the database;
receiving at the server second vendor information from a second vendor device associated with a second vendor;
storing the second vendor information in a second vendor profile in the database;
establishing a current value of second loyalty points corresponding to the customer associated with the customer device and the second vendor;
receiving first interaction information from one or more of the customer device and the first vendor device describing a first interaction between the customer associated with the customer device and the first vendor;
updating the current value of the first loyalty based upon the first interaction information;
receiving second interaction information from one or more of the customer device and the second vendor device describing a second interaction between the customer associated with the customer device and the second vendor; and
updating the current value of the second loyalty points based upon the second interaction information.

19. The method of claim 18, wherein the server comprises a proximity engine and the method further comprises:
receiving at the proximity engine a current location of the customer device; and
the proximity engine determining whether the current location of the customer device is in proximity to a location of the first vendor device.

20. The method of claim 19, further comprising:
the server transmitting a notification to the first vendor device that the customer device is in proximity to the first vendor device.

21. The method of claim 18, wherein receiving the first interaction information comprises:
receiving an indication from one or more of the customer device and the first vendor device that the customer device and the first vendor device are in proximity to each other.

22. The method of claim 18 wherein at least one of the first interaction and the second interaction includes a purchase.

23. The method of claim 18 wherein at least one of the first interaction and the second interaction includes the customer staying a length of time in an area determined by the vendor.

24. The method of claim 18 wherein at least one of the first interaction and the second interaction includes the customer entering an area determined by the vendor.

25. The method of claim 18 wherein the server comprises an analytics engine and the method further comprises:
the analytics engine determining data describing aggregate customer interactions with the first vendor; and
transmitting the data to the vendor device.

26. The method of claim 25, wherein the data concerns trends within customer interactions with the first vendor.

27. A method for distributing loyalty rewards to a plurality of consumers for a plurality of vendors, wherein a vendor device is associated with one of the vendors, the method comprising:
the vendor device establishing communication with a server and a customer device associated with one of the customers;
determining that the customer device is in proximity to the vendor device;
receiving customer identification information from at least one of the server and the customer device;
displaying the customer information on a display of the vendor device;
receiving, from a database on the server, a current value of loyalty points associated with the customer corresponding to the customer device and the vendor corresponding to the vendor device;
recording interaction information concerning an interaction between the customer and the vendor;
transmitting the interaction information to the server; and
receiving an updated value of the loyalty points from the server in response to the transmitted interaction information.

28. The method of claim 27 wherein determining that the customer device is in proximity to the vendor device comprises receiving a notification from the server that customer device is in proximity to the vendor device.

29. The method of claim 27 wherein determining that the customer device is in proximity to the vendor device comprises determining that the customer device is on the same local area network (LAN) as the vendor device.

30. The method of claim 27 wherein determining that the customer device is in proximity to the vendor device comprises establishing direct, short-range wireless communication with the vendor device.

31. The method of claim 27 wherein recording the interaction information comprises receiving information describing the interaction input via a user interface of the vendor device.

32. The method of claim 27 wherein recording the interaction comprises automatically recording the interaction.

33. The method of claim 27 wherein the interaction includes a purchase.

34. The method of claim 33 further comprising:
completing the purchase automatically via the communication established between the customer device and the vendor device.

35. The method of claim 34, wherein completing the purchase automatically via the communication established between the customer device and the vendor device includes receiving customer payment information from at least one of the server and the customer device.

36. The method of claim 27 further comprising receiving from the server data concerning trends within customer interactions with the vendor associated with the vendor device.

37. The method of claim 27 further comprising receiving from the server aggregate information about others vendors.

38. The method of claim 27 further comprising:
transmitting vendor information regarding the vendor associated with the vendor device to the customer device.

39. The method of claim 38, wherein transmitting the vendor information comprises transmitting the vendor information via a direct, short-range wireless communication with the customer device.

40. The method of claim 38, wherein transmitting the vendor information comprises transmitting the vendor information to the customer device indirectly via the server.

41. The method of claim 27 further comprising:
receiving customer location information.

42. In a customer device associated with a customer, a method for tracking and utilizing loyalty rewards at a plurality of vendors comprising:
establishing communication with a server;
determining that the customer is in proximity to a vendor device associated with one of the vendors; and
in response to determining that the customer device is in proximity to the vendor device:
receiving the vendor identification information;
receiving a current value of loyalty points associated with the customer and the vendor from a database on the server;
displaying the vendor identification information and the current value of the loyalty points on a display of the customer device;
recording interaction information concerning an interaction between the customer and the vendor;
transmitting the interaction information to the server; and
receiving an updated value of the loyalty points from the server in response to the transmitted interaction information.

43. The method of claim 42 further comprising transmitting customer information to the vendor device.

44. The method of claim 43 further comprising transmitting payment information to the vendor device.

45. The method of claim 42, wherein determining that the customer is in proximity to the vendor device associated with one of the vendors comprises:
determining a current location of the customer device;
transmitting the current location to the server; and
receiving an indication from the server that the customer device is in proximity to the vendor device.

46. The method of claim 42, wherein determining that the customer device is in proximity to the vendor device associated with one of the vendors comprises establishing direct, short-range wireless communication with the vendor device.

47. The method of claim 42 wherein determining that the customer device is in proximity to the vendor device comprises determining that the customer device is on the same local area network (LAN) as the vendor device.
